(19) United States
(12) Patent Application Publication
(10) Pub. No.: US 2015/0036020 A1
(43) Pub. Date: Feb. 5, 2015

(54) METHOD FOR SHARING ORIGINAL PHOTOS ALONG WITH FINAL PROCESSED IMAGE

(71) Applicant: NVIDIA Corporation, Santa Clara, CA (US)

(72) Inventors: Patrick Shehane, Fremont, CA (US); Guanghua Zhang, Sunnyvale, CA (US)

(73) Assignee: NVIDIA Corporation, Santa Clara, CA (US)

(21) Appl. No.: 13/959,383

(22) Filed: Aug. 5, 2013

(51) Int. Cl. H04N 5/76

(52) U.S. Cl. CPC H04N 5/76
USPC 348/231.2

(57) ABSTRACT

A method for storing digital images is presented. The method comprises accessing a first image. It further comprises capturing at least one second image. Further, it comprises storing metadata associated with the at least one second image in at least one field within a file format of the first image, wherein the file format defines a structure for the image, and wherein the at least one field is located within an extensible segment of the file format. In one embodiment, the at least one second image is an image that is intermediate in relation to the first image, wherein the at least one second image is selected from a group consisting of: intermediate HDR images; RAW Bayer image data; RGB image data; RAW images; multiple exposures captured to produce a single final image.

### CROSS-REFERENCE TO RELATED APPLICATIONS

### Related Applications

The present application is related to U.S. patent application Ser. No. ______, filed ______, entitled “A METHOD FOR CAPTURING THE MOMENT OF THE PHOTO CAPTURE,” naming Peter Mikolajczyk, Patrick Shehane and Guanghua Gary Zhang as inventors, and having attorney docket number NVID-PSC-120857-US1. That application is incorporated herein by reference in its entirety and for all purposes.

The present application is related to U.S. patent application Ser. No. ______, filed ______, entitled “A METHOD FOR SHARING DIGITAL PHOTOS SECURELY,” naming Patrick Shehane and Guanghua Gary Zhang as inventors, and having attorney docket number NVID-PSC-120858-US1. That application is incorporated herein by reference in its entirety and for all purposes.

### FIELD OF THE INVENTION

Embodiments according to the present invention generally relate to capturing images and more specifically to methods for storing captured images.

### BACKGROUND OF THE INVENTION

Image file formats are standardized means of organizing and storing digital images. Image files are composed of digital data in one of these formats that can be rasterized for use on a computer display or printer. An image file format may store data in uncompressed, compressed, or vector formats. When rasterized, an image becomes a grid of pixels, each of which has a number of bits to designate its color equal to the color depth of the device displaying it. Including certain proprietary types, there are hundreds of image file types. Some image file formats typically used to display images on the Internet are Graphics Interchange Format (GIF), Portable Network Graphics (PNG), and JPEG File Interchange Format (JFIF). Joint Photographic Experts Group (JPEG) is one popular method for compressing images circulated on the Internet, and JPEG-compressed images are usually stored in the JFIF file format or Exchangeable image file format (EXIF).

While various types of image formats are currently employed for storing and transmitting images by digital cameras and other portable electronic devices with image capturing capabilities, conventional image file formats are typically limited in the type of information that can be stored and transmitted along with the image data. In part, this limitation exists in the various standards for storing and transmitting images, e.g. JFIF, EXIF, etc., in order to minimize the storage space required to store and bandwidth required to transmit the images. However, with storage becoming increasingly cheaper and broadband speeds increasing, the inability to transmit different types of associated information along with the images poses a needless limitation on the user.

Further, another limitation with conventional image capturing and storing techniques is that the processing operations performed on an image to get it to its final form, e.g., a compressed JPEG image, is destructive. Accordingly, there is no way to recover the original or intermediate information from the various stages that an image must go through before it reaches its final form, e.g., RGB data, etc. Even where certain digital image capturing and processing systems allow users to capture and store both RAW or JPEG versions of an image, there is typically no mechanism provided to keep the files associated and grouped together.

This problem is especially noticeable when capturing certain types of images that require multiple images to create a single final image, e.g., high-dynamic-range (HDR) or panorama images. HDR photographs are generally achieved by capturing multiple standard photographs, often using exposure bracketing, and then merging them into an HDR image. Panorama images are generally produced with an expanded field of view by stitching multiple images of different viewpoints. Conventional image capturing systems do not allow the multiple images captured and used to create the final image to be saved or associated with each other. This is problematic because the users lose the ability to use the intermediate images to perform more detailed processing. Further, users lose the ability to save those images and run a different image processing procedure on them in time when image processing capabilities improve.

### BRIEF SUMMARY OF THE INVENTION

Accordingly, a need exists for systems and methods for storing all intermediate versions of a final digital image product. For example, not only would the JPEG versions of a digital image be captured, but also the intermediate Raw Bayer data and RGB data of an image would be saved. Also, a need exists for systems and methods for easily associating all the intermediate and related files and data with a final image product, so that they can be easily found when a user needs to access them.

In addition, a need exists for systems and methods for enhancing users' interactions with digital images by allowing the user to encode other types of information, e.g., audio data, GPS data, time data, orientation data, information regarding related images, information regarding intermediate images including image data, location, number, size etc. within certain designated segments of the corresponding image file format

In one embodiment, the present invention stores information regarding intermediate and related images of a final image in a field within an extensible segment of the file format for the final image. In one embodiment, for example, entire intermediate and related images and corresponding data can be saved in uncompressed or lossless compressed form within the fields comprising intermediate and related image information respectively. In another embodiment, only thumbnails of the related and intermediate images are stored. And in yet another embodiment, links, pointers, file paths, or other useful information for the related and intermediate images can be stored within the field of the extensible segment in the final image.

Embedding additional metadata regarding related and intermediate images along with the final image data in a digital image is advantageous because it allows users to easily access and quickly assess the quality of the images, e.g., an associated RAW image. Further, it allows all the intermediate and related images to be grouped together in the event that the user needs to access them in the future. Additionally, saving and allowing an easy point of access to the intermediate images is helpful because as image processing capabilities continue to improve, a user may want to return to a group of intermediate images in the future and reprocess them using newer procedures. Alternatively, a user may have initially downloaded a set of final images onto a computer with a lower processing power, but may want to reprocess them again at a later time on a computer with additional memory and computational resources using all the intermediate versions of the final images. Finally, the present invention would be desirable for a professional photographer who may need to use all the different images captured for creating an HDR image, for example, and process them all separately to create a final product.

In one embodiment, a method for storing digital images is presented. The method comprises accessing a first image. It further comprises capturing at least one second image. Further, it comprises storing metadata associated with the at least one second image in at least one field within a file format of the first image, wherein the file format defines a structure for the image, and wherein the at least one field is located within an extensible segment of the file format. In one embodiment, the at least one second image is an image that is intermediate in relation to the first image, wherein the at least one second image is selected from a group consisting of: intermediate HDR images; Bayer image data; RGB image data; RAW images; multiple exposures captured to produce a single final image.

In another embodiment, a method for decoding an image is presented. The method comprises receiving a first image from a digital image capture device, wherein the image comprises a file format with an extensible segment, and wherein the extensible segment comprises at least one field for storing metadata associated with at least one second image. Further, it comprises displaying the first image within a user interface, wherein the user interface comprises an option to access the metadata.

In one embodiment, an apparatus for storing digital images is presented. The apparatus comprises a display screen configured to display a first image, a memory, at least one digital camera, and a processor. The processor is configured to: (a) capture the first image using one of the at least one digital camera; (b) capture at least one second image; and (c) store metadata associated with the at least one second image in at least one field within a file format of the first image, wherein the file format defines a structure for the first image, and wherein the at least one field is located within an extensible segment of the file format.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows an exemplary computer system 100 used to capture and/or display images in accordance with one embodiment of the present invention.

FIG. 2 shows an exemplary operating environment of a device capable of storing associated metadata in the images captured by the device in accordance with one embodiment of the present invention.

FIG. 3 is a high level block diagram illustrating the elements of the image system proposed in accordance with an embodiment of the present invention.

FIG. 4 is a block diagram illustrating the various intermediate versions of a JPEG image.

FIG. 5 illustrates the modification of a JFIF segment to incorporate associated metadata in accordance with an embodiment of the present invention.

FIG. 6 illustrates the modification of a JFIF extension segment to incorporate associate metadata in accordance with an embodiment of the present invention.

FIG. 7 illustrates an exemplary method of displaying images with associated metadata in accordance with an embodiment of the present invention.

FIG. 8 illustrates an exemplary method of providing options to access the metadata concerning related and intermediate images associated with an image on display in accordance with an embodiment of the present invention.

FIG. 9 illustrates the contents of the intermediate and related images fields in an exemplary file format for an image in accordance with an embodiment of the present invention.

FIG. 10 depicts a flowchart of an exemplary process of storing and accessing associated metadata pertaining to related and intermediate images in a segment of an image on the image capture device in accordance with one embodiment of the present invention.

FIG. 11 depicts a flowchart of an exemplary process of receiving and accessing associated metadata pertaining to related and intermediate images in a segment of an image from an image capture device in accordance with one embodiment of the present invention.

FIG. 12 is a more detailed block diagram of an exemplary computer system and illustrates the various hardware and software components for storing and organizing images in both the camera and the software application in accordance with one embodiment of the present invention.

In the figures, elements having the same designation have the same or similar function.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Notation and Nomenclature

Some portions of the detailed descriptions that follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

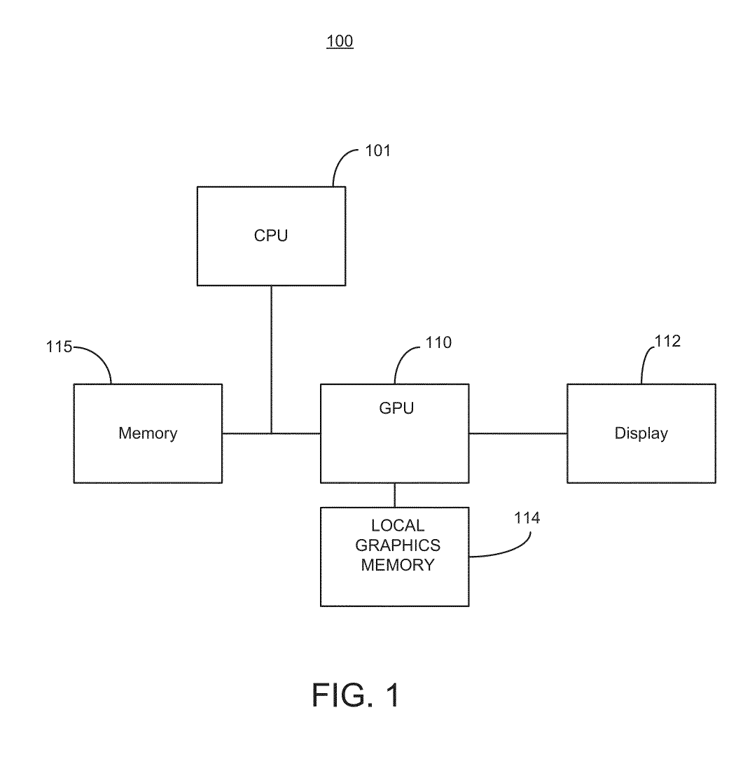

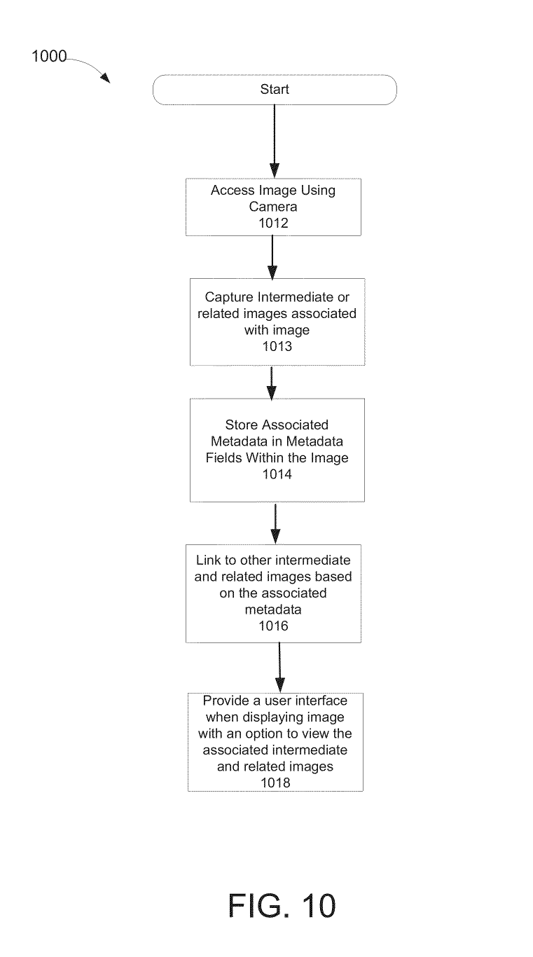

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “capturing,” “storing,” “linking,” “providing,” “receiving,” “running,” and “organizing,” or the like, refer to actions and processes (e.g., flowchart 1000 of FIG. 10) of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 shows an exemplary computer system 100 used to capture and/or display images in accordance with one embodiment of the present invention. Computer system 100 depicts the components of a generic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 may be coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cell-phone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

A Method for Sharing Original Photos Along with Final Processed Image

Most conventional image formats in commercial use today constrict the scope of what a user can do with a captured image. More specifically, conventional image formats do not have the flexibility to allow images to provide for designated segments within the file format of the image to store associated metadata, e.g., information pertaining to related or intermediate images that can be accessed by the user while viewing the image or otherwise.

Accordingly, embodiments of the present invention provide for systems and methods for enhancing users' interactions with digital images by allowing the user to encode other types of information, e.g., audio data, time data, GPS data, related and intermediate image information within certain designated segments of the corresponding image file format. Further, in one embodiment of the present invention, a dynamic, non-standard image file format is provided that has fields allocated for storing various types of associated information or metadata related to the image data including intermediate and related image information. In a different embodiment, the present invention provides a method for modifying standardized image formats, e.g., the JFIF image format to allow additional related metadata to be included in designated fields within the image.

Additionally, embodiments of the present invention provide for systems and methods for storing all intermediate versions of a final digital image product. For example, not only would the JPEG versions of a digital image be captured, but also the intermediate RAW Bayer data and/or RGB data of an image would be saved. Also, embodiments of the present invention provide for systems and methods for easily associating all the intermediate files and data with a final image product, so that they can be easily found when a user needs to access them. Further, embodiments of the present invention provide for methods and systems for storing information regarding all related images to a digital image as well, e.g., all images taken within a certain geographic distance, or within a certain timeframe of the image.

In one embodiment, the present invention stores information regarding intermediate and related images of a final image in a field within an extensible segment of the file format for the final image. In one embodiment, an entire intermediate image or images and corresponding data can be saved within the field comprising related image information in uncompressed or lossless compressed form. In another embodiment, only thumbnails of the intermediate images are stored. And in yet another embodiment, links, pointers, file paths, or other useful information for the intermediate images can be stored within the field of the extensible segment in the final image.

Embedding additional metadata regarding related and intermediate images along with the final image data in a digital image is advantageous because it allows users to easily access and quickly assess the quality of the images, e.g., an associated RAW Bayer image. Further, it allows all the intermediate and related images to be grouped together in the event that the user needs to access them in the future. Additionally, saving and allowing an easy point of access to the intermediate images is helpful because as image processing capabilities continue to improve, a user may want to return to a group of intermediate images in the future and reprocess them using newer procedures. Accordingly, the present invention prevents related and intermediate images from getting misplaced if a user needs to access them for further processing in the future.

Alternatively, a user may have initially downloaded a set of final images onto a computer with a lower processing power, but may want to reprocess them again at a later time on a computer with additional memory and computational resources using all the intermediate versions of the final images. Instead of needing to manually organize all intermediate versions of final images and keep track of them, the user using embodiments of the present invention can simply access the information stored in the additional metadata fields of one of the final images to determine how and where the related or intermediate images are organized and grouped.

Finally, the present invention would be desirable for a professional photographer who may need to use all the different images captured for creating an HDR image, for example, and process them all separately to create a final product.

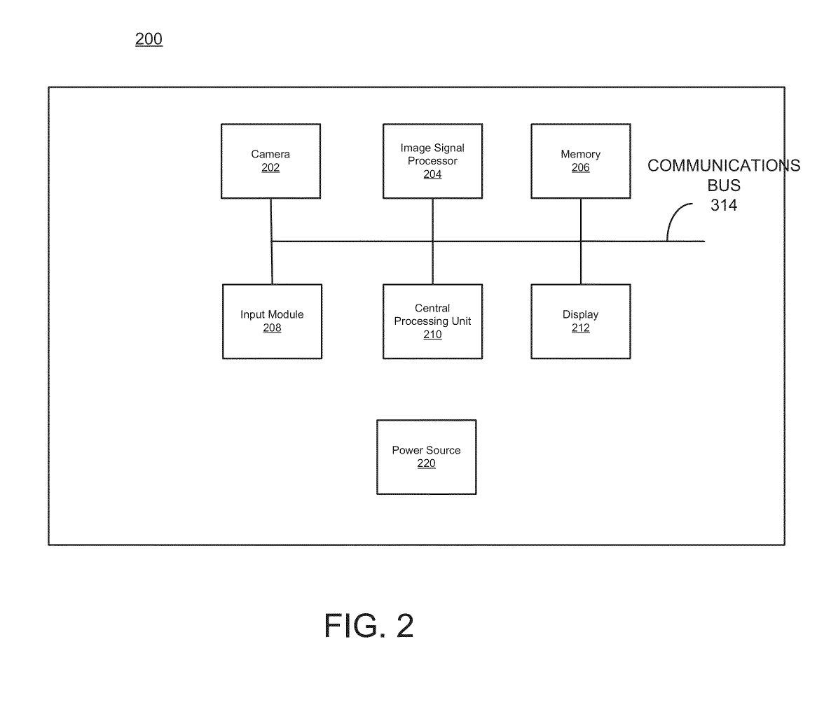

FIG. 2 shows an exemplary operating environment of a device capable of storing associated metadata in the images captured by the device in accordance with one embodiment of the present invention. System 200 includes camera 202, image signal processor (ISP) 204, memory 206, input module 208, central processing unit (CPU) 210, display 212, communications bus 214, and power source 220. Power source 220 provides power to system 200 and may be a DC or AC power source. System 200 depicts the components of an exemplary system in accordance with embodiments of the present invention providing the execution platform for certain hardware-based and software-based functionality. Although specific components are disclosed in system 200, it should be appreciated that such components are examples. That is, embodiments of the present invention are well suited to having various other components or variations of the components recited in system 200. It is appreciated that the components in system 200 may operate with other components other than those presented, and that not all of the components of system 200 may be required to achieve the goals of system 200.

CPU 210 and the ISP 204 can also be integrated into a single integrated circuit die and CPU 210 and ISP 204 may share various resources, such as instruction logic, buffers, functional units and so on, or separate resources may be provided for image processing and general-purpose operations. System 200 can be implemented as, for example, a digital camera, cell phone camera, portable device (e.g., audio device, entertainment device, handheld device), webcam, video device (e.g., camcorder) or any other device with a front or back facing camera that allows the device to detect the presence of a user.

In one embodiment, camera 202 captures light via a front-facing or back-facing lens (depending on how the user typically holds the device), and converts the light received into a signal (e.g., digital or analog). In another embodiment, system 200 may also have another camera facing away from the user (not shown). Camera 202 may comprise any of a variety of optical sensors including, but not limited to, complementary metal-oxide-semiconductor (CMOS) or charge-coupled device (CCD) sensors. Camera 202 is coupled to communications bus 214 and may provide image data received over communications bus 214. Camera 202 may comprise functionality to determine and configure optical properties and settings including, but not limited to, focus, exposure, color or white balance, and areas of interest (e.g., via a focus motor, aperture control, etc.).

In one embodiment, camera 202 in FIG. 2 represents two cameras, one with a lower resolution than the other camera, as disclosed in co-pending applications, U.S. patent application Ser. No. 13/609,019, titled “System and Method for Enhanced Monoimaging” filed on Sep. 10, 2012, and U.S. patent application Ser. No. 13/609,062, titled “System and Method For Enhanced Stereo Imaging,” filed on Sep. 10, 2012, both of which are incorporated herein by reference in their entirety and for all purposes. In a different embodiment, camera 202 may also represent a front facing and a back facing camera both of which are operable to capture images contemporaneously.

Image signal processor (ISP) 204 is coupled to communications bus 214 and processes the signal generated by camera 204, as described herein. More specifically, image signal processor 204 may process data from camera 202 for storing in memory 206. For example, image signal processor 204 may compress and determine a file format for an image to be stored in within memory 206. Further, by of example, image signal processor may be configured to add metadata related to the image within the file format for the image as well. Alternatively, CPU 210 could also be configured to populate the designated segments within the file format of the image with the related metadata, e.g., audio clips related to the image.

Input module 208 allows entry of commands into system 200 which may then, among other things, control the sampling of data by camera 202 and subsequent processing by ISP 204. Input module 208 may include, but it not limited to, navigation pads, keyboards (e.g., QWERTY), up/down buttons, touch screen controls (e.g., via display 212) and the like.

Central processing unit (CPU) 210 receives commands via input module 208 and may control a variety of operations including, but not limited to, sampling and configuration of camera 202, processing by ISP 204, and management (e.g., addition, transfer, and removal) of images and/or video from memory 206.

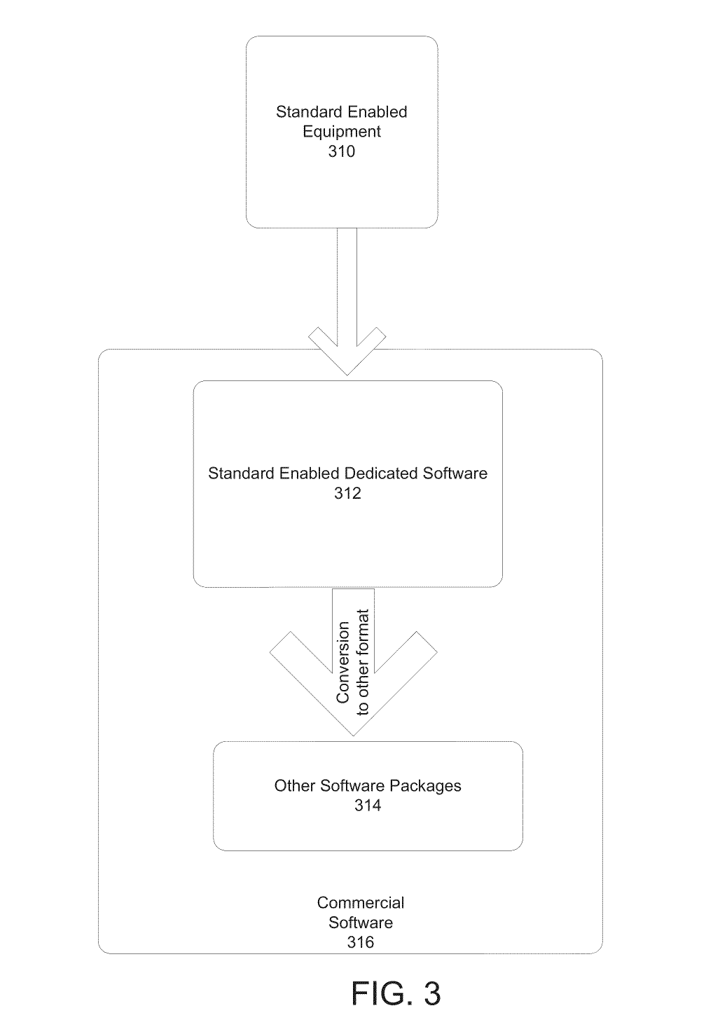

FIG. 3 is a high level block diagram illustrating the elements of the image system proposed in accordance with an embodiment of the present invention. In one embodiment of the present invention, standard enabled equipment 310 is capable of capturing and storing images with associated metadata, including metadata for intermediate and related images, in designated segments of the image file format. A basic condition of the equipment 310 with a playback function is that it be able to read the files it recorded itself. In one embodiment, standard enabled equipment 310 performs a similar function to system 200 in FIG. 2.

The protocol used for storing images by equipment 310 can be a modified variation to an existing standard, e.g., JFIF that has been altered to accommodate additional metadata fields. Alternatively, in one embodiment, the equipment 310 can store images in accordance with a new standard that has designated fields for embedding associated metadata, e.g., intermediate and related image information, audio etc. The standard enabled equipment 310 can be an imaging device such as a camera, or a portable electronic device such as a phone, tablet, etc. that is capable of capturing images.

The standard enabled equipment 310 can, in one embodiment, communicate with a standard enabled dedicated software 312 that is operable to receive and decode the images and associated metadata from the equipment 310. In the personal computer environment, for example, the requirement would be that the dedicated software 312 be able to read all the images from equipment 310 including all the associated metadata and attribute information in conformance with the modified or new file format standard. In one embodiment, the dedicated software 312 is a type of commercial software 316 that is widely available commercially or provided by the manufacturer of equipment 310. In one embodiment, the dedicated software 312 can be configured to allow the user to view the image while presenting the option to view or access the associated metadata stored in a designated field within the image. In one embodiment, the dedicated software 316 can be used to convert the images with associated metadata into formats that are recognized by standard commercial software packages 314.

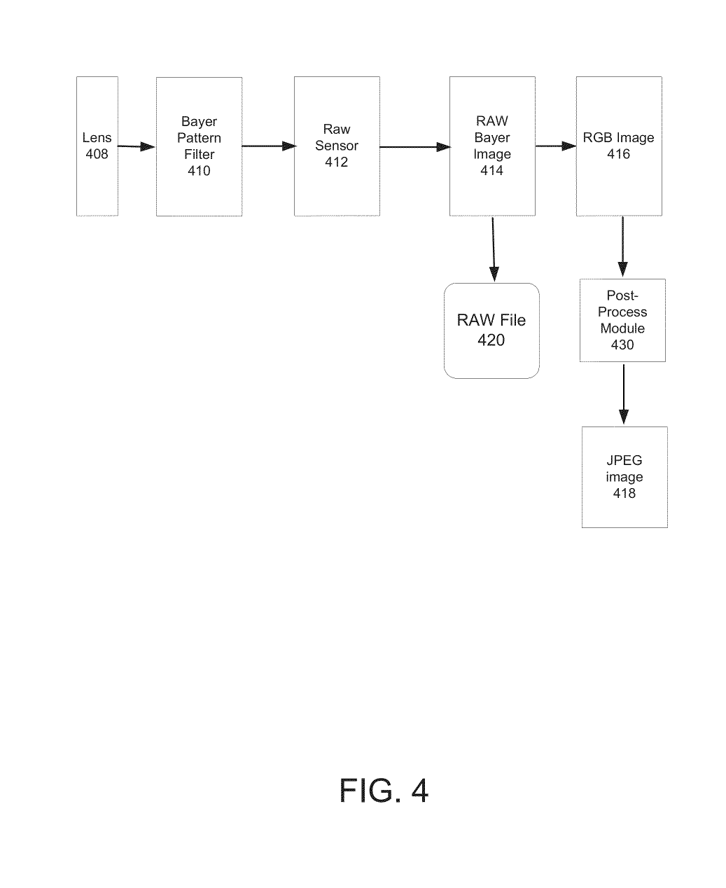

As discussed above, embodiments of the present invention provide methods and systems for storing intermediate instances of images as they are processed. FIG. 4 is a block diagram illustrating the various intermediate versions of a JPEG image. Between a lens 408 of the camera and the RAW sensor 412 typically resides a Bayer pattern filter 410. A Bay filter mosaic is a color filter array for arranging RGB color filters on a square grid of photo sensors. Its particular arrangement of color filters is used with most single-chip digital image sensors used in digital cameras to create a color image. The RAW output of Bayer-filter cameras, as shown in FIG. 4, is referred to as a RAW Bayer image 414. Since each pixel is filtered to record only one of three colors, the data from each pixel cannot fully determine color on its own. To obtain a full-color image, various demosaicing procedures can be used to interpolate a set of complete red, green and blue (RGB) values for each point resulting in RGB image 416. Different procedures requiring various amounts of computing power and compression levels using post-process module 430 result in varying-quality final images. This can be done in-camera, producing, for example, a JPEG/JFIF image. Further, composite images such as HDR or panoramic images are typically created from multiple intermediate images, e.g., RAW Bayer image data 414 or RGB images 416, using post-process module 430. Alternatively, the RAW data file 420 can be saved from the RAW Bayer image buffer data 414.

The problem with conventional cameras, as discussed above, is that twofold. First, they do not provide any means to store intermediate images, e.g. RAW Bayer image data 414, RAW image files 420, or RGB image 416. Further, if they provide an ability to save intermediate images separately from a JPEG image 418, they do not provide any way to establish a linkage or association between the two images, so a user can easily keep track of the associated images. As will be discussed further below, embodiments of the present invention address both these issues.

There are several possible ways to define a new standard for an image file format that designates segments for the storage of associated metadata in accordance with embodiments of the present invention.

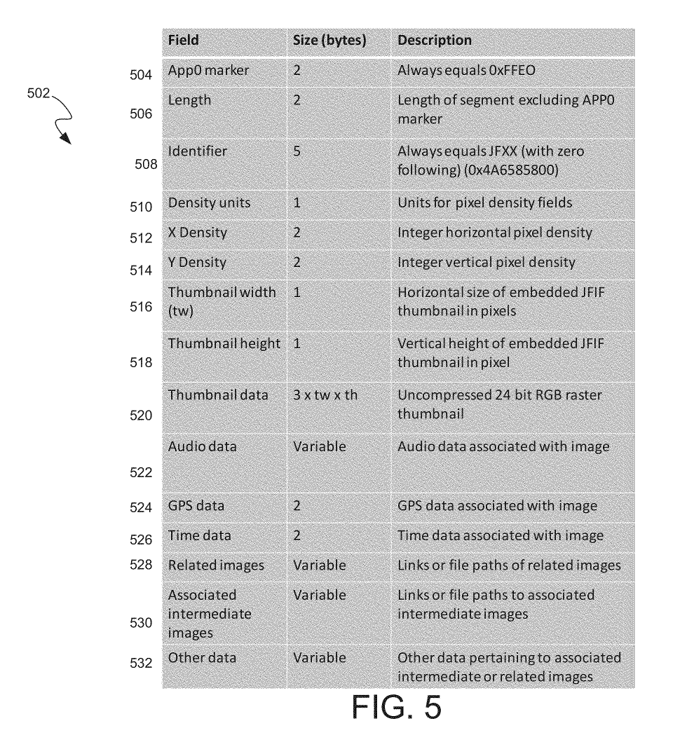

Similarly, there are several techniques for modifying existing file formats to support storage of associated metadata. One such file format, as discussed above, is JFIF. JFIF is designed to allow files containing JPEG-encoded streams to be exchanged between otherwise incompatible systems and applications. FIG. 5 illustrates the modification of a JFIF segment 502 to incorporate associated metadata in accordance with an embodiment of the present invention.

A valid JFIF file must typically start with a two-byte start-of-image (SOI) marker (not shown) which is 0xFFD8. This is followed by a JFIF APP0 (Application) marker 504, immediately following the SOI, which consists of the marker code values 0xFFEO and the characters “JFIF” in the marker data. Although JFIF files do not possess a formally-defined header, the SOI and JFIF APP0 markers taken together act as a header in the marker segment structure 502 illustrated in FIG. 5. The length field 506 is the size of the JFIF marker segment 502, including the size of the length field 506 itself and any thumbnail data contained in the APP0 segment.

The other field that are conventionally present in a JFIF (APP0) marker segment are as follows: a) an identifier field 508 used to identify the code stream as conforming to the JFIF specification; b) a density units field 510 to identify units for pixel density fields; c) an X Density field 512 and a Y Density field 514 to identify the unit of measurement used to describe the image resolution; d) a thumbnail width 516 to define the horizontal size of embedded JFIF thumbnail; e) a thumbnail height 518 to define the height of an embedded JFIF thumbnail; and f) thumbnail data 520 comprising the image data for the thumbnail.

In addition to the conventional fields defined in the JFIF (APP0) marker segment, in one embodiment of the present invention, the JFIF (APP0) marker segments can be extended to incorporate additional fields, e.g., fields 522, 524, 526, 528, 530 and 532 in FIG. 5, in order to provide the flexibility and convenience to embed metadata associated with the image. For example, an audio data field 522 can be added to the marker segment that embeds a short encoded audio clip related to the image within the image itself. Embedding an encoded audio clip in the image file itself is advantageous, because while in some cases an image by itself can be sufficient, in most cases users may want to record other sensory input contemporaneous with the taking of the image. For example, if the user is proposing to his girlfriend, it would be highly desirable to be able to capture a few seconds of audio right before and after the capturing of the image in order to record the buildup to the moment including his fiancé's reaction to the proposal.

While most cameras nowadays can record video, simply capturing a video of the occasion does not provide the desired functionality and flexibility because videos in most cases are much lower quality than simply capturing an audio image. Also, typically a single representative image of an event like a wedding proposal, a goal in a soccer game, or a student's graduation can be much more memorable than a video clip. In addition, finding a single representative image from a video clip comprising 30 to 40 seconds of footage, for example, is more challenging that simply capturing a single image when the timing is right. Further, in certain cases the user may just want a still image of the occasion while having the flexibility to listen to a brief audio clip related to the image.

In one embodiment, the recording of the audio clip is activated when the user initiates the focusing process so as to capture a few seconds of audio before the actual image is captured. In another embodiment, the audio clip can start recording when the user actuates the image capture trigger.

In other embodiments, a separate pushbutton can be provided to activate the audio recording, so that the audio capture process is not tied to image capture. The user can then be presented an option to choose the image that the audio clip should be associated with. The equipment 310 can then encode the audio clip and embed it in the designated segment of the file format for the user specified image.

In one embodiment, the user is provided with the flexibility to control the length of the audio clip. The user may do this using a user interface on equipment 310 or software 312 that allows the user to control options related to the captured images. Accordingly, the size of field 522 in the JFIF (APP0) marker segment is variable.

In one embodiment, the present invention allows GPS data 524 to also be embedded in, for example, the marker segment of the JFIF file as shown in FIG. 5. This GPS metadata field can be used for various purposes, including, for example, to group related images by equipment 310 and dedicated software 312. As will be explained further below, in one embodiment, the GPS field can be encrypted for privacy reasons so that it can be accessed by equipment 310 and software 312 to identify and group related images, but may not be accessed for viewing in a publicly readable format or for any other purpose. In one embodiment, the GPS field can be used to organize and group pictures automatically as they are captured by equipment 310.

In one embodiment, the present invention allows time data 526 to also be embedded in, for example, the marker segment of the JFIF file as shown in FIG. 5. While conventional image formats may allow the time of image capture to be saved with the image file, the present invention allows the time to be embedded in a dedicated field that can then be used to search for and identify related images taken within a certain time duration. Further, in one embodiment, the present invention may allow the user to have control over the time data field 526 and be able to manually adjust it if needed either using equipment 310 or software 312. Also, in one embodiment, the time field may be encrypted for privacy reasons.

In one embodiment, the present invention allows related image data 528 to be embedded in, for example, the marker segment of the JFIF file as shown in FIG. 5. The related images field 528 can, in one embodiment, be variable. Related image data can be stored in any number of various ways. For example, in one embodiment, links or pointers to all the various related images can be stored within this field. In a different embodiment, field 528 can comprise a file path for all related images. In yet another embodiment, field 528 can comprise a thumbnail of all related images. It may even comprise one or more short related movies regarding the image. In a different embodiment, related images field 528 may comprise full versions of all the related images resulting in a large file size for the JFIF file.

In one embodiment where full sized versions of related images need to be preserved within the image, a standard such as Motion JPEG (MJPEG) may also be used. As is well-known, MJPEG is a video format in which each frame is compressed separately as a JPEG image. In one embodiment of the present invention, the MJPEG standard could be altered so that an image and all its related images can be stored within one file.

The criteria for what constitutes a related image may be ascertained by the user and entered through a user interface into the image capture settings available in equipment 310 or software 312. Exemplary criteria that can be used to identify related images are time of image, GPS location data in image, file name, file path, user annotation in field 532 (discussed in more detail below), etc. For example, a user may choose to identify all images taken on her birthday as a related image. In this case, time field 526 may be used to identify the relevant images. Subsequently, links would be added to the related images field 528 to images taken on the user's birthday that can be accessed by the equipment 310 or software 312. In one embodiment, if the storage space on equipment 310 is limited, then the software 312 can be configured to perform another search to identify further related images after the images are downloaded from equipment 310 to software 312.

In one embodiment, a voice speech search procedure may be employed on the audio data 522 field of the images to identify related images. For example, the voice speech search could be used to search all images where the “Happy Birthday” song is sung. Once the related images have been identified, information regarding these images is subsequently added in field 528.

In one embodiment, related images can be images captured immediately preceding or following the moment of shutter press. When capturing a photo of a moment, either of family, friends, or a scene, several images preceding and proceeding the time of shutter press can be captured, encoded and saved in field 528 so that a later playback can provide more than just a static representation of that moment in time. In one embodiment, a short movie capture could be saved as well in the related images field 528.

Co-pending applications, U.S. patent application Ser. No. 13/609,019, titled “System and Method for Enhanced Monoimaging” filed on Sep. 10, 2012, and U.S. patent application Ser. No. 13/609,062, titled “System and Method For Enhanced Stereo Imaging,” filed on Sep. 10, 2012, discloses a system comprising two cameras wherein, in one embodiment, the pictures using the two cameras may be captured substantially simultaneously. In one embodiment of the present invention, each of the images captured by the respective camera could comprise an embedded link or thumbnail of the image captured by the other camera.

Similarly, in one embodiment, for devices that comprise both a front facing and back facing camera, images could be captured by both cameras substantially simultaneously. Further, associated metadata could be stored in field 528 of each image comprising information regarding the image captured by the other camera on the same device. Further, a first image taken from the front facing camera could be authenticated using information from a second image taken using the back facing camera and stored within field 528 of the first image. For example, the second image taken by the back facing camera may be a picture of the individual taking the photograph. This image could then be used to authenticate the first image, wherein the second image is encoded within a segment of the first image.

In one embodiment, the present invention allows associated intermediate image data 530, e.g., intermediate HDR or panoramic pictures using RAW Bayer image data, RGB image data, etc., to be embedded in, for example, the marker segment of the JFIF file as shown in FIG. 5. The associated intermediate images field 530 can, in one embodiment, be variable. Associated intermediate image data can be stored in any number of various ways. For example, in one embodiment, links or pointers to all the various intermediate images can be stored within this field. In a different embodiment, field 530 can comprise a file path for all intermediate images. In yet another embodiment, field 530 can comprise a thumbnail of all intermediate images. In a different embodiment, intermediate images field 530 may comprise full versions of all the intermediate images resulting in a large file size for the JFIF file.

There can be several different types of intermediate images as discussed above in connection with FIG. 4. For example, intermediate image information can comprise RAW Bayer image data 414, RGB image data 416, or even the RAW image files 420. Also, as discussed above, HDR images are typically created using multiple intermediate images. HDR is a digital photography technique whereby multiple exposures of the same scene are layered and merged using image editing procedures to create a more realistic image, or a dramatic effect. The combined exposures can display a wider range of tonal values than what the digital camera is capable of recording in a single image. Embodiments of the present invention can advantageously be used to group and keep track of the various intermediate images that are used to capture a final HDR image. As elaborated above, the intermediate image field 530 of the final HDR image can comprise links, file paths, thumbnails, or other information to associate the image with all its intermediate versions. Similarly, panoramic images can be created using various intermediate images as well.

Certain conventional devices also have the ability to capture several pictures consecutively after shutter press, wherein the multiple intermediate pictures are used to adjust undesirable visual affects such as poor lighting or jitter. For example, certain cameras have shooting modes that stitch together multiple exposures of one scene into a single, crisp photo to account for poor lighting. In one embodiment, each of these captured final images will embed links, thumbnails or other identifying information for the intermediate images that are captured during the same brief segment of time following shutter press.

In one embodiment, present invention allows other data 532 to be embedded in, for example, the marker segment of the JFIF file as shown in FIG. 5. This field is flexible and can comprise many different types of associated metadata, e.g., text annotation, voice annotation, gyro sensor data, heat sensor data, etc.

For example, in one embodiment, camera orientation data from an accelerometer or gyro sensor may be embedded for the HDR, panoramic or other types of images. By way of another example, in one embodiment, field 532 can comprise a user annotation regarding a particular image. The annotation can be either textual or verbal. If verbal, then an audio clip is encoded into field 532 with the user's annotation. In one embodiment, the annotation field 532 may be manipulated by the user at any point in time after capturing the image. Similar to the functionality for the audio data 522, this feature allows the user the flexibility to pair any audio clip with an image after it has been taken. This can be useful if the user is creating, for example, a slideshow to be viewed with dedicated software 312.

In one embodiment, dedicated software 312 or even equipment 310 can be configured to have slideshow capabilities, and further configured to display images in the slideshow in a way such that the associated audio clip either from the audio data field 522 or from the other field 532 for an image is played in full while displaying the image and before transitioning to the next image. The user may, in one embodiment, be able to choose the field (e.g., 522 or 532) that the audio clips should be accessed from while viewing the slideshow.

Further, the slideshow capabilities may be configured to also display the related images identified in field 528 when displaying an image to the extent any are specified. In one embodiment, the slideshow may also be programmed to display all the intermediate versions of an image using field 530.

In a different embodiment, field 532 may comprise a user's setting regarding sharing permissions for the image. For example, the user may specify within the image with whom the image may be shared on a social networking website, e.g., Facebook. The software 312 would then recognize the user's setting after the image has been transferred over from equipment 310 and automatically upload the image to the designated social networking site with the user specified permission settings. The user, in one embodiment, could also specify the permission settings for the related images in field 528 and intermediate images in field 530. For example, the user may be a professional photographer and may not want others to have access to the RAW version of his final image.

In one embodiment, all the associate metadata fields, e.g., fields 522, 524, 526, 528, 530 and 532 are encrypted and can only be accessed by a user or device possessing the necessary key to decrypt the information. For example, in certain embodiments, as discussed above, the user may not want to share access to the related or intermediate versions of his image. Also, in certain instance, while the user may want the flexibility of preserving GPS data in an image for personal reasons, the user may not desire to have the GPS metadata published if the image is shared through email or via a social networking site. In such cases, it is beneficial to have the option to encrypt the metadata fields so the user has control over the sharing of the associated metadata fields. In one embodiment, certain associated metadata fields, e.g., time and GPS data, can be encrypted and hidden from everyone including the user, and only used by standard enabled equipment 310 and dedicated software 312 for sorting and organizational purposes and to identify related and/or intermediate images. In one embodiment, the user may be able to choose through a user interface whether or not the associated metadata fields should be encrypted.

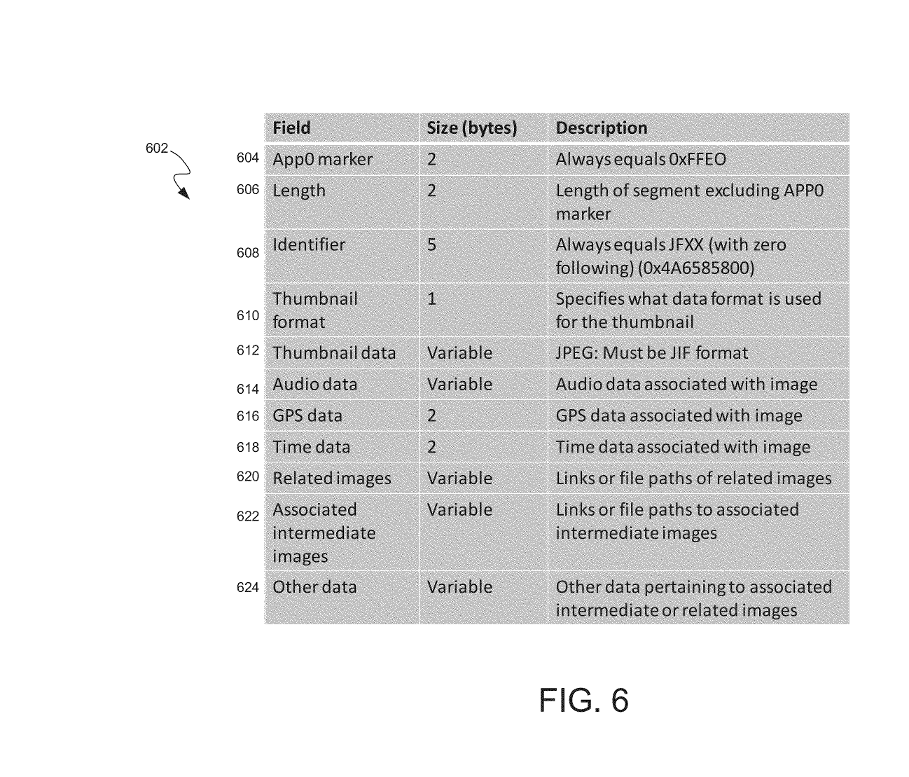

In a typical JFIF image, following the JFIF marker segment, there may be one or more optional JFIF extension marker segments. Extension segments are used to store additional information. FIG. 6 illustrates the modification of a JFIF extension segment to incorporate associate metadata in accordance with an embodiment of the present invention.

Similar to FIG. 5, certain fields shown in FIG. 6 are also found in a conventional JFIF extension marker segment. For example, a typical JFIF extension marker segment will comprise the APP0 marker 604 with the value 0xFFEO, a length field 606, an identifier 608, a thumbnail format 610, and thumbnail data 612.

In accordance with an embodiment of the present invention, the JFIF extension marker segment can be modified to include additional fields such as the audio data field 614, the GPS data field 616, the time data field 618, the related images field 620, the associated intermediate image field 622, and the other data field 622. Fields 614, 616, 618, 620, 622, and 624 work in substantially the same way as the corresponding fields in FIG. 5.

It is worth noting that while the present invention has been discussed in the context of the JFIF image file format, the novel aspects and techniques of the invention can be used with any number of various different file formats as well. For example, the Exchangeable image file format (EXIF) is a standard that specifies the formats for images used by digital cameras and scanners also. One of the fields that the EXIF standard defines in its specification is a “Makernote” field which typically has a storage capacity of between 0 and 64 kilobytes. The EXIF standard defines a MakerNote tag, which allows camera manufacturers to place custom format metadata in the file typically related to the digital camera settings, e.g., shooting modes, focusing modes, etc. The present invention can also be applied to extending the Markernote field of the EXIF standard to include the additional metadata discussed above, e.g., audio data, related image information, intermediate image information, GPS data, time data, etc.

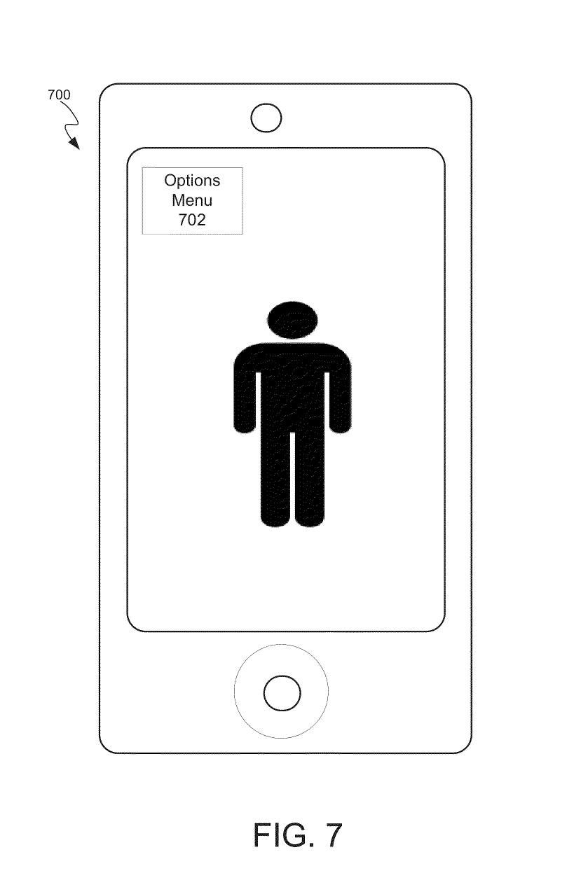

FIG. 7 illustrates an exemplary method of displaying images with associated metadata in accordance with an embodiment of the present invention. In order to display images and the associated embedded metadata, device 700 should be configured so that it can read the images including all the associated metadata and attribute information in conformance with the modified or new file format standard taught by the present invention. Device 700 can either be an example of standard enable equipment 310, or it could also have the standard enabled dedicated software 312 installed onto it. Traditional devices that do not have the dedicated software to display the associated metadata will simply display the image in the conventional way without allowing the user the option to access the embedded fields.

As shown in FIG. 7, when an image with associated metadata is displayed on the screen of device 700, an icon 702 can appear on the screen alerting the user that additional data associated with the image is available for access.

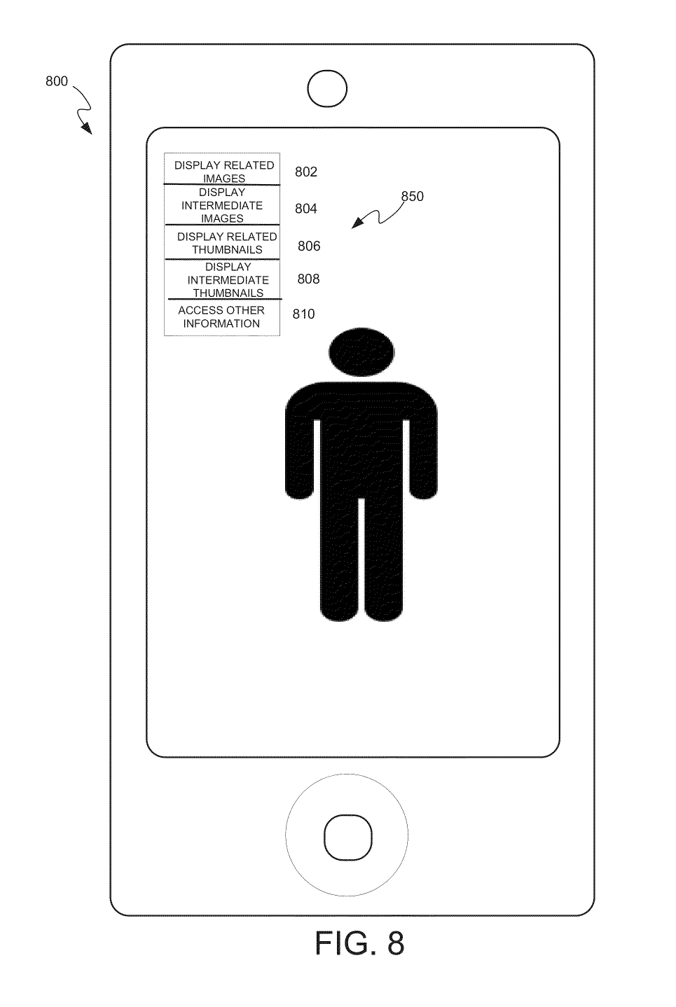

When the user clicks on the options icon 702 appearing on screen, a drop down menu of options becomes available to the user in accordance with one embodiment of the present invention. FIG. 8 illustrates an exemplary method of providing options to access the metadata concerning related and intermediate images associated with an image on display in accordance with an embodiment of the present invention.

The drop down menu 850 allows the user to display related images 802 from the related images field 528, to display intermediate images 804 from the associated intermediate images field 530, to display related image thumbnails 806 using the information from the related images field 528, to display intermediate image thumbnails 808 using information from the intermediate image field 530, and finally also access all the other metadata 810 stored with the image, e.g., associated audio clip from field 522, GPS data from field 524, time data from field 526, and other data from field 532. Of course, if certain data, e.g., associated intermediate image data 530, or GPS data 424, is encrypted and unavailable, options pertaining to those fields in the options menu 850 will be dimmed.

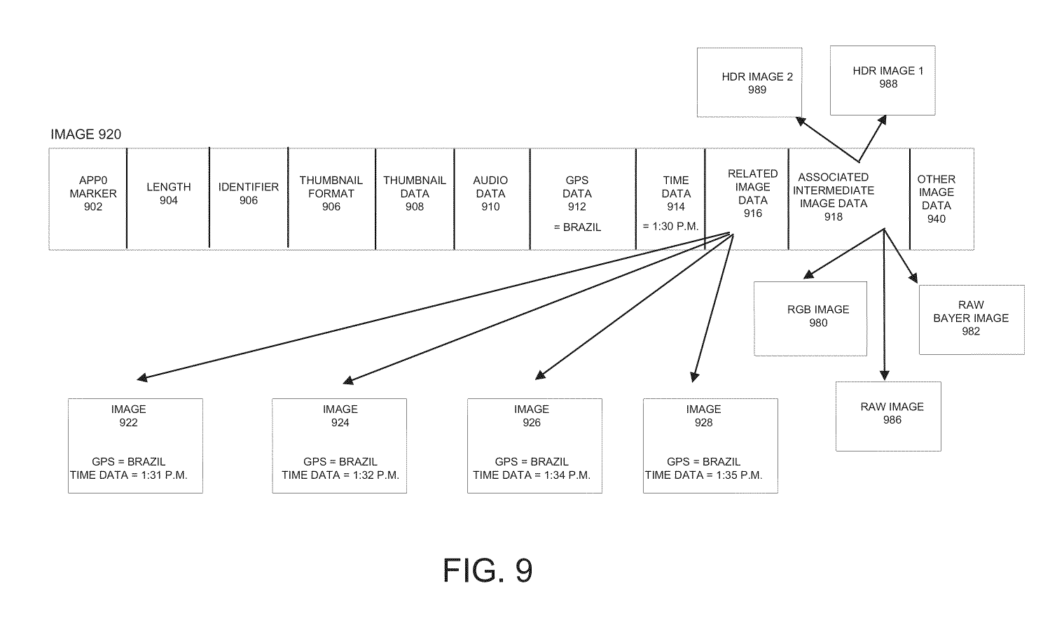

FIG. 9 illustrates the contents of the intermediate and related images fields in an exemplary file format for an image in accordance with an embodiment of the present invention. Image 920 has similar fields to the file format illustrated in FIG. 6, with an APP0 marker field 902, a length field 904, an identifier field 906, a thumbnail format field 906, a thumbnail data field 908, an audio data field 910, a GPS data field 912, a time data field 914, a related image data field 916, an associated intermediate image data field 918, and an other image data field 940.

In one embodiment of the present invention, the pointers or links in the related image field 916 can be populated based on data in the GPS data field 912 and the time data field 914. For example, the software on device equipment 310 or the application 312 can both be enabled to populate the related image data 916 based on a prescriptive rule that operates on fields 912 and 914 and selects images that are taken within a certain radius of the location pointed to by the GPS data 912 and within a certain time duration of the time data 914. In the example of FIG. 9, the application of the prescriptive rule identifies all the other images, 922, 924, 926 and 928, on equipment 310 that were taken in Brazil around the 1:30 p.m. timeframe.

In different embodiments of the present invention, the prescriptive rule can be structured to identify other types of related images as well, e.g., images captured by a second camera on the same device as discussed above, images captured in quick succession in burst mode, etc.

In one embodiment of the present invention, the data in the GPS field 912 and time data field 914 can also be used to organize all the images in a folder structure both on equipment 310 and on a computer running software application 312 after the images have been transferred over from equipment 310. For example, the GPS data can be used as a primary criterion for sorting images. Images taken at different locations, e.g., locations more than 50 miles away from each other, can be placed in different folders. The time data can then be utilized as a secondary criterion to organize images within each folder. For example, within the Brazil folder created for the images identified in FIG. 9, the images would be sorted in the following order: Image 922 at 1:32 p.m., Image 924 at 1:34 p.m., Image 926 at 1:34 p.m., and Image 928 at 1:35 p.m. Of course, in addition to the GPS field 912 and time data field 914, images can be organized based on criterion extracted from the other metadata fields as well.

In one embodiment of the present invention, associated intermediate image data field 918, as shown in FIG. 9, can be used to keep track of different kinds of intermediate images. The types of intermediate images that field 918 keeps track of can be established by a user specified prescriptive rule similar to related image data field 916. In one embodiment, intermediate image data field 918 can be used to store information pertaining to HDR images used to create the final image 920, e.g., HDR Image 1 988 and HDR image 2 989. In another embodiment, intermediate image data field 918 can be used to store information pertaining to RGB image data 980, RAW Bayer image data 982 and RAW image 986. In other embodiments, field 918 can be used to store information regarding other intermediate images captured for performing jitter and low exposure adjustments. As explained above, the information for all the above described embodiments can be stored in field 918 as links, file paths, thumbnails, or even full images in a format such as MJPEG. The information can also be updated by storing the information regarding intermediate images in field 918 as it is captured, or by updating the information periodically based on a user prescriptive rule.

FIG. 10 depicts a flowchart of an exemplary process of storing and accessing associated metadata pertaining to related and intermediate images in a segment of an image on the image capture device in accordance with one embodiment of the present invention.

At step 1012, an image is accessed with a camera, which functions substantially similarly to standard enabled equipment 310 and device 700. This image can either be captured using the camera in one embodiment, or in a different embodiment, the image can be created using a plurality of intermediate images, e.g., intermediate HDR images, or intermediate panoramic images.

At step 1013, related or intermediate image data is captured. For example, in cameras equipped with HDR capability, several images may be captured to create a final HDR image. In one embodiment, step 1013 may execute substantially simultaneously with step 1012. For example, RAW Bayer data 982 or RGB data 980 may be captured simultaneously with the capturing of the image at step 1012.

In certain embodiments, devices with two cameras may capture related images for field 528 substantially simultaneously as well. Or in other embodiments, the related images may be captured consecutively, e.g., images related based on GPS coordinates.

At step 1014, the captured image is stored with all the relevant associated metadata in the respective fields, e.g., related image information in field 528 or intermediate image information in field 530. As discussed above, this metadata can be saved in several different formats, e.g., links, file paths, thumbnails etc.

At step 1016, the captured image, in one embodiment, can link to other related and intermediate images based on user specified criteria that uses data in other metadata fields, e.g., GPS, time, etc. The links or pointers to these intermediate or related images can be stored in the related image data field 528 and intermediate image data field 530 respectively of the captured image. In one embodiment, a prescriptive rule is run when the image is stored that searches for and identifies all such related images available on the camera. In other embodiments, intermediate image data can be stored in field 530 and respective image data can be stored in field 528 at the time the image is captured. For example, when intermediate images for HRD images are captured, links to those images can be stored right away in field 530.

At step 1018, the camera recognizes the image as having a specialized file format with associated metadata fields and displays the captured image with a user interface that provides the user with an option to access the associated metadata. One example of this interface is provided in FIG. 9 in the form of a menu of available options 950.

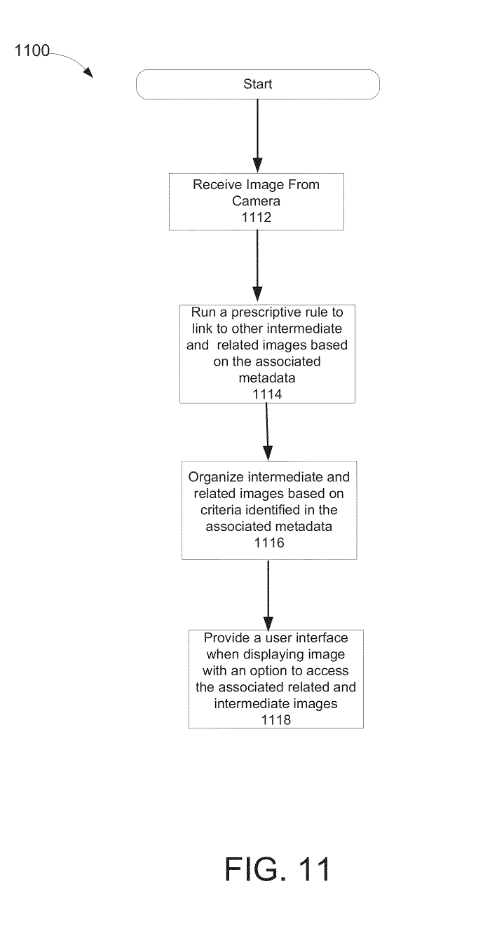

FIG. 11 depicts a flowchart of an exemplary process of receiving and accessing associated metadata pertaining to related and intermediate images in a segment of an image from an image capture device in accordance with one embodiment of the present invention.

At step 1112, a personal computer or any other type of computing device that is capable of connecting with the camera (or equipment 310) and has the dedicated software 312 installed on it receives the captured image from the camera.

At step 1114, the prescriptive rule to identify intermediate and related images may be run again, in one embodiment, to update the related image data field 528 and intermediate data image field 530 in the image to account for the possibility that the computing environment on which the image is downloaded contains more related and intermediate images than were available on the camera. The related image data field 528 and intermediate image data field 530 is subsequently updated in accordance with the results provided by the prescriptive engine.

At step 1116, the images related and intermediate to the downloaded image can be organized based on user specified criteria that use data in the other associated metadata fields. For example, the user may want all his related images organized based on location primarily, but may designate all the images associated with a particular location to be organized by time. Accordingly, as shown in FIG. 9, the images can be grouped primarily based on location and then sorted using time as a secondary criterion. Or, for example, the user may want all his RAW images grouped into the same folder on his personal computer, so the images can be accessed easily when the user has more computational power available on a different computer. By way of further example, a user may want all his Bayer image data information grouped into one location that he plans to revisit in the future with the benefit of more advanced processing procedures.

Finally, at step 1118, the dedicated software 312 is also operable to provide an interface for displaying the image with an option to view the associated metadata as shown in FIG. 8.

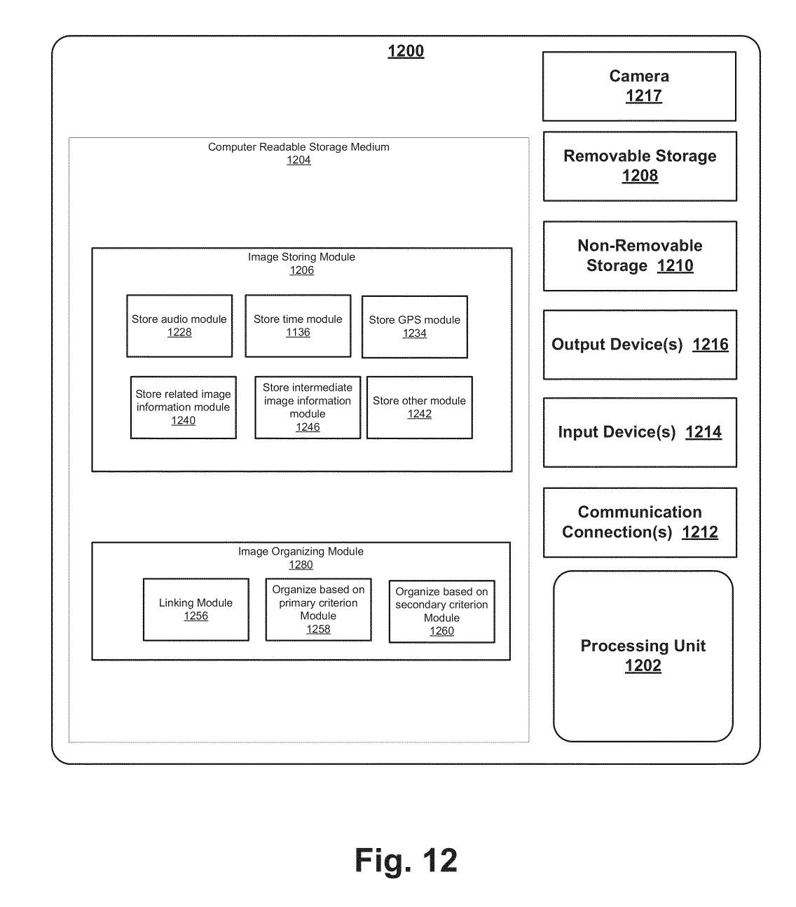

FIG. 12 is a more detailed block diagram of an exemplary computer system and illustrates the various hardware and software components for storing and organizing images in both the camera and the software application in accordance with one embodiment of the present invention. The camera, in one embodiment, functions substantially similarly to equipment 310, and the software application functions substantially similarly to dedicated software 312.

FIG. 12 shows a block diagram of an exemplary computing system environment 1200, in accordance with one embodiment of the present invention. With reference to FIG. 12, an exemplary system module for implementing embodiments includes a general purpose computing system environment, such as computing system environment 1200. Computing system environment 1200 may include, but is not limited to, laptops, tablet PCs, notebooks, mobile devices, and smartphones. In its most basic configuration, computing system environment 1200 typically includes at least one processing unit 1202 and computer readable storage medium 1204. Depending on the exact configuration and type of computing system environment, computer readable storage medium 1204 may be volatile (such as RAM), non-volatile (such as ROM, flash memory, etc.) or some combination of the two. Portions of computer readable storage medium 1204 when executed facilitate image or video capture.

Additionally, computing system environment 1200 may also have additional features/functionality. For example, computing system environment 1200 may also include additional storage (removable and/or non-removable) including, but not limited to, magnetic or optical disks or tape. Such additional storage is illustrated in FIG. 12 by removable storage 1208 and non-removable storage 1210. Computer storage media includes volatile and nonvolatile, removable and non-removable media implemented in any method or technology for storage of information such as computer readable instructions, data structures, program modules or other data. Computer readable medium 1204, removable storage 1208 and nonremovable storage 1210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1200. Any such computer storage media may be part of computing system environment 1200.

Computing system environment 1200 may also contain communications connection(s) 1212 that allow it to communicate with other devices. Communications connection(s) 1212 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 1212 may allow computing system environment 1200 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1212 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 1200 may also have input device(s) 1214 such as a keyboard, mouse, pen, voice input device, touch input device, remote control, etc. Output device(s) 1216 such as a display, speakers, etc. may also be included. All these devices are well known in the art and are not discussed at length.

Computing system environment 1200 can also have an image storing module 1206. Image storage module 1206 comprises store audio module 1228, which is responsible for accessing and encoding associated audio data into the audio data field 522 of the image. Store time module 1236 is responsible for accessing and encoding associated time data into the time data field 526 of the image. Store GPS module 1234 is responsible for accessing and encoding associated GPS data into the GPS data field 524 of the image. Store related image information module 1240 is responsible for accessing and encoding associated related image information data into the related image data field 528 of the image. Store intermediate image information module 1246 is responsible for accessing and encoding associated intermediate image information into the associated intermediate image data field 530. Store other module 1242 is responsible for accessing and encoding associated other data into the other data field 532 of the image.

Computing system environment 1200 may also have an image organizing module 1280. Image organizing module can comprise linking module 1256, organize based on primary criterion module 1258, and organize based on secondary criterion module 1260. Linking module 1256 is responsible for running the prescriptive engine responsible for linking the related and intermediate image data fields, 428 and 430 respectively, of an image with associated images. Module 1258 organizes the related and intermediate images based on a primary criterion, e.g., GPS, identified by a user, HDR images. Module 1260 then sorts the images in each of the categories from the first categorization by module 1258 based on a secondary user specified criterion, e.g., time.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method for storing digital images, said method comprising:
accessing a first image;
capturing at least one second image; and
storing metadata associated with said at least one second image in at least one field within a file format of said first image, wherein said file format defines a structure for said image, and wherein said at least one field is located within an extensible segment of said file format.

2. The method of claim 1, wherein said at least one second image is captured substantially simultaneously with said first image.

3. The method of claim 1, wherein said at least one second image is an image related to said first image, wherein said at least one second image is selected from a group consisting of: geographically related images; images related based on time of capture; images captured by different cameras on a single device; images related based on a user annotation; and images related based on a location of storage.

4. The method of claim 1, wherein said at least one second image is an image that is intermediate in relation to said first image, wherein said at least one second image is selected from a group consisting of: intermediate HDR images; RAW Bayer image data; RGB image data; RAW images; multiple exposures captured to produce a single final image.

5. The method of claim 1, wherein said at least one second image comprises a plurality of images, and wherein said accessing comprises:
generating said first image using said plurality of images, wherein said plurality of images are intermediate in relation to said first image.

6. The method of claim 1, wherein said accessing comprises capturing said first image using a camera.

7. The method of claim 5, wherein said plurality of images comprise intermediate HDR images.

8. The method of claim 1, wherein said metadata is selected from a group consisting of: links to said at least one second image; file paths of said at least one second image; thumbnails of said at least one second image; and full image data for said at least one second image.

9. The method of claim 1, wherein said file format is a modification to a predetermined file format, wherein said existing file format is selected from a group consisting of: JFIF, EXIF, TIFF, PNG, and GIF.

10. The method of claim 1, wherein at least one type of metadata is full image data for said at least one second image, and wherein said file format is a modification to MJPEG.

11. The method of claim 1, wherein at least one type of said metadata is related image information, and wherein said storing comprises:
linking said first image to at least one related image; and
embedding information to perform said linking in a field within said file format, wherein said field is dedicated to storing said related image information.

12. The method of claim 11, wherein said linking comprises:
executing a user specified prescriptive rule using at least one type of said metadata, wherein said at least one type of metadata is selected from a group consisting of: GPS data and time data.

13. The method of claim 1, wherein at least one type of said metadata is intermediate image information, and wherein said storing comprises:
linking said first image to at least one intermediate image; and
embedding information to perform said linking in a field within said file format, wherein said field is dedicated to storing said intermediate image information.

14. The method of claim 1 further comprising:
displaying said first image within a user interface, wherein said user interface comprises an option to access said metadata, wherein said metadata is selected from a group consisting of: related image information and intermediate image information.

15. A method for decoding an image, said method comprising:
receiving a first image from a digital image capture device, wherein said image comprises a file format with an extensible segment, and wherein said extensible segment comprises at least one field for storing metadata associated with at least one second image; and
displaying said first image within a user interface, wherein said user interface comprises an option to access said metadata.

16. The method of claim 15, wherein said metadata is selected from a group consisting of: related image information and intermediate image information.

17. The method of claim 15, wherein said at least one second image is an image related to said first image, wherein said at least one second image is selected from a group consisting of: geographically related images; images related based on time of capture; images captured by different cameras on a single device; images related based on a user annotation; and images related based on a location of storage.

18. The method of claim 15, wherein said at least one second image is an image that is intermediate in relation to said first image, and wherein said at least one second image is used to generate said first image, and further wherein said at least one second image is selected from a group consisting of: intermediate HDR images; RAW Bayer image data; RGB image data; RAW images; multiple exposures captured to produce a single final image.

19. The method of claim 15, wherein at least one type of said metadata is related image information associated with said at least one second image, and wherein said storing comprises:
linking said first image to said at least one second image; and
embedding information to perform said linking in a field within said file format, wherein said field is dedicated to storing said related image information.

20. The method of claim 15, wherein at least one type of said metadata is intermediate image information associated with said at least one second image, and wherein said storing comprises:
linking said first image to said at least one second image; and
embedding information to perform said linking in a field within said file format, wherein said field is dedicated to storing said intermediate image information.

21. An apparatus for storing digital images, said apparatus comprising:
a display screen configured to display a first image;
a memory;
at least one digital camera;
a processor configured to:
capture said first image using one of said at least one digital camera;
capture at least one second image; and
store metadata associated with said at least one second image in at least one field within a file format of said first image, wherein said file format defines a structure for said first image, and wherein said at least one field is located within an extensible segment of said file format.

22. The apparatus of claim 21, wherein said at least one second image is an image related to said first image, wherein said at least one second image is selected from a group consisting of: geographically related images; images related based on time of capture; images captured by different cameras on a single device; images related based on a user annotation; and images related based on a location of storage.

23. The apparatus of claim 21, wherein said at least one second image is an image that is intermediate in relation to said first image, wherein said at least one second image is selected from a group consisting of: intermediate HDR images; RAW Bayer image data; RGB image data; RAW images; multiple exposures captured to produce a single final image.
